(19) United States
(12) Patent Application Publication
(10) Pub. No.: US 2007/0056995 A1
(43) Pub. Date: Mar. 15, 2007

(54) Fluid dispenser with trapping well and stabilizing well

(76) Inventor: Kevin Cotter, Rohnert Park, CA (US)

Correspondence Address: Cary Tope-McKay, 22852 Pacific Coast Highway #311, Malibu, CA, 90265, US

(21) Appl. No.: 11/451,976

(22) Filed: Jun. 12, 2006

Related U.S. Application Data
(60) Provisional application No. 60/689,271, filed on Jun. 10, 2005.

(51) Int. Cl. B67D 5/40

(52) U.S. Cl. 222/377; 222/464.7

(57) ABSTRACT

Described is a fluid dispenser for dispensing a fluid. The fluid dispenser comprises a dispenser apparatus with a dip tube for drawing the fluid there through. A container is attached with the dispenser apparatus. The container is formed to have a trapping well and a separate stabilizing well. The trapping well includes a bottom portion and is formed such that when upright, fluid in the trapping well is directed toward the bottom portion. The trapping well is also formed such that the dip tube extends vertically from the dispenser apparatus to the bottom portion of the trapping well. Furthermore, the trapping well and stabilizing well are formed proximate one another and with a space therebetween.

### PRIORITY CLAIM

The present application is a non-provisional patent application, claiming the benefit of priority of U.S. Provisional Application No. 60/689,271, filed on Jun. 10, 2005, entitled, “Prime-Assisting, Circular Liquid-Concentrating Well with Stabilizing Well for Supply Containers used in conjunction with a Pump Spray Device.”

### FIELD OF INVENTION

The present invention relates to a fluid dispenser, and more particularly, to a pump spray device that includes both a liquid-trapping well and a stabilizing well.

### BACKGROUND OF INVENTION

Spray bottles are devices that contain a fluid within a container and are typically used to dispense the fluid upon a surface. Spray bottles generally include a dip tube that is disposed within the container. When a user actuates a pump mechanism, the fluid is pumped through the dip tube and dispersed from the container. A problem with typical spray bottles is that at some point, the fluid level reaches a point at which the dip tube begins to draw air. As the dip tube begins to draw air, the pump mechanism is no longer primed which results in the spray bottle sputtering a combination of fluid and air, as opposed to spraying the fluid. Because the dip tube draws air at low fluid levels, it is virtually impossible to dispense all of the fluid from the container, resulting in waste and unused toxic chemicals being sent to landfills.

In an attempt to solve the problem of a spray bottle losing prime, others have added a weighted tip to the end of a flexible dip tube. The result of these designs is that the dip tube is supposed to move in the container along with the fluid, hence a mechanical operation. By way of example, U.S. Pat. No. 5,195,664, issued to Rhea (hereinafter referred to as “the Rhea patent”), discloses a spray bottle having a weighted dip tube. The Rhea patent states that the prior art does “not have the ability to self-right” with the “unfavorable result that it is not possible to pick-up low levels of liquid from the bottle.” Though the Rhea patent contends that the invention therein solves such a problem, the inventor approached the issue by altering the pump mechanism's dip tube. Based on an arcing pendulum motion of the weighted dip tube, the dip tube is still not able to reach the containers contents when the bottle is used at an angle at low liquid levels. Thus, a more effective approach to addressing this problem is in addressing the design of the spray bottle container itself.

A redesign of the spray bottle container was disclosed in U.S. Pat. No. 5,279,450, issued to Witt, Jr. (hereinafter referred to as “the Witt patent”). The Witt patent discloses a spray bottle container having a partition to create two chambers. The partition is represented by an interior wall that starts at the base in the bottom corner of the container (creating a wedge-shaped chamber). The interior wall slants in an upward direction towards the neck of the container to create two separate chambers (i.e., the wedge-shaped chamber and a reservoir chamber). The top of the interior wall has an opening that allows the two chambers to communicate fluid there between. In operation, the dip tube is positioned towards the bottom of the wedge-shaped chamber to allow fluid concentrated there to be drawn into the dip tube. While effective for concentrating fluid toward the dip tube, there are several problems with the invention described by the Witt patent. First, the shape of the container requires that a user snake the dip tube towards the bottom of the wedge-shaped chamber. Snaking the dip tube can be difficult to do and may require additional tools. Second, the shape described in the Witt patent includes an interior wall which can be extremely difficult to form using standard bottle manufacturing techniques. Third, the bottom of the wedge-shaped container includes multiple corners (with the dip tube centered therebetween), meaning that the fluid is not necessarily concentrated at the entrance to the dip tube, especially when the spray bottle is being used at an angle.

Thus, a continuing need exists for a spray bottle that uses gravity to concentrate liquids within a trapping well to keep the liquid concentrated around the dip tube when the spray bottle is low in contents or being used at an angle. Additionally, a need exists for the aforementioned spray bottle to be in a form that can be easily created using standard bottle making techniques.

### SUMMARY OF INVENTION

The present invention relates to a fluid dispenser. The fluid dispenser comprises a container for holding a fluid. The container includes a neck portion for connecting with a dispenser apparatus. Further, the container is formed to have a trapping well and a separate stabilizing well. The trapping well includes a bottom portion and is formed such that when upright, fluid in the trapping well is directed to the bottom portion. The trapping well is also formed such that a dip tube can be extended vertically from a dispenser apparatus to the bottom portion of the trapping well.

In another aspect, the present invention includes a dispenser apparatus for dispensing the fluid. A dip tube having a first end and a second end is attached with the dispenser apparatus via the first end. The second end is open for drawing the fluid into the dispenser apparatus.

In yet another aspect, the container is formed such that the trapping well is proximate the stabilizing well and a space exists between the trapping well and the stabilizing well.

The trapping well can be formed in multiple shapes. For example, the trapping well is formed in circular shape. In another aspect, the trapping well is formed to have a circular portion and a tapered portion. In yet another aspect, the trapping well is formed to have tapered portions around the bottom portion.

Additionally, the container includes a finger groove section formed proximate the neck portion, thereby allowing a user to hold the fluid dispenser at least partially through using the finger groove section.

As can be appreciated by one skilled in the art, the present invention also comprises a method for forming and using the fluid dispenser described herein. The method for forming the fluid dispenser comprises multiple acts of forming and connecting the various parts and portions of the fluid dispenser. The container is formed using a blow-molding technique. The method for using the fluid dispenser comprises multiple acts of dispensing the fluid and moving the container to direct the fluid toward the trapping well.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration of a fluid dispenser according to the present invention;

FIG. 2 is a close-up view illustration of a trapping well and stabilizing well according to the present invention;

FIG. 3 is a cross-sectional side-view illustration of a container according to the present invention;

FIG. 4 is a cross-sectional side-view illustration of a container according to the present invention;

FIG. 5 is a perspective-view illustration of a fluid dispenser according to the present invention; and

FIG. 6 is a cross-sectional side-view illustration of a fluid dispenser according to the present invention.

### DETAILED DESCRIPTION

The present invention relates to a pump spray device, and more particularly, to a pump spray device that includes a liquid-trapping well and a stabilizing well.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of various principal aspects of the present invention is provided. Subsequently, an introduction is presented to provide the reader with a general understanding of the present invention. Finally, details of the present invention are provided to give an understanding of the specific details.

(1) Principal Aspects

The present invention has three “principal” aspects. The first is an apparatus. The apparatus is a pump spray device having both a liquid-trapping well and a stabilizing well. The second principal aspect is a method for forming the pump spray device. The method includes a plurality of acts, which when performed, result in the device of the present invention. Finally, the present invention includes a method for using the apparatus described herein.

(2) Introduction

Spray bottles of the prior art typically lose their prime when the contents of the spray bottles are at low levels. Losing the prime causes traditional spray bottles to draw air and discontinue spraying the fluid. The present invention improves upon the prior art by allowing spray bottles and like dispensing containers to not lose their prime as their contents are expelled at lower levels, or when the bottle is used at virtually any angle with respect to a ground surface. The method and apparatus of the present invention, when coupled with a traditional blow or injection-molded bottle, will alleviate the frustration that many users experience when their spray bottle loses prime.

The present invention uses gravity to concentrate liquids within a circular trapping well to keep the liquid concentrated around the dip tube when the spray bottle is either low in contents, being used at an angle, or both. The result of this design is that the liquid contents of the container are always forced to or contained within the area of the dip tube so that air does not interfere with the prime of the outgoing spray.

(3) Details of the Invention

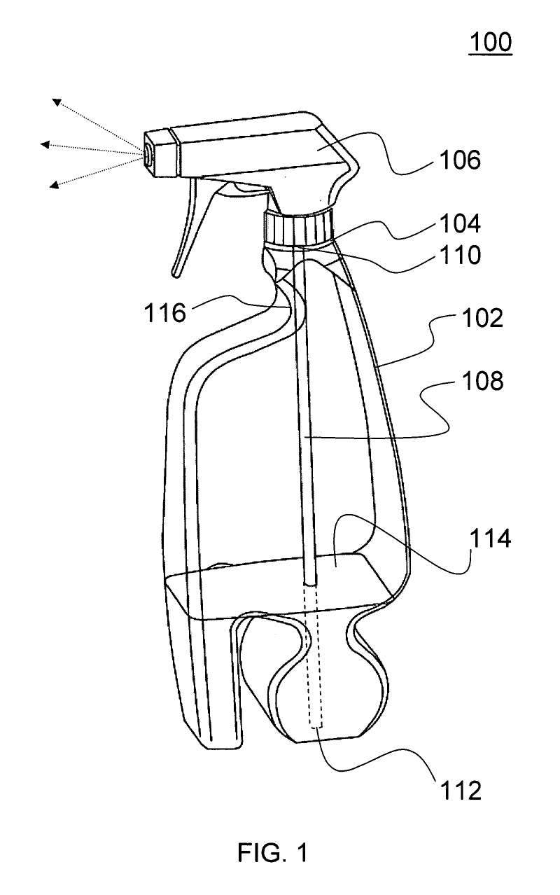

As shown in FIG. 1, the present invention is a fluid dispenser 100 that includes a container 102 for holding a fluid. The container 102 is formed out of any suitably durable material, a non-limiting example of which includes plastic.

The container 102 includes a neck portion 104 for connecting with a dispenser apparatus 106. A dip tube 108 having a first end 110 and a second end 112 is attached with the dispenser apparatus 106 via its first end 110. The second end 112 is open for drawing a fluid 114 into the dispenser apparatus 106. The dispenser apparatus 106 is any suitable mechanism or device for drawing the fluid 114 proximate the second end 112 into and through the dispenser apparatus 106 for dispensing upon a surface, a non-limiting example of which includes a hand-pump, spray mechanism.

To assist a user in holding the fluid dispenser 100, the container 102 includes a finger groove section 116. The finger groove section 116 is formed proximate the neck portion 104. As can be appreciated by one skilled in the art, the finger groove section 116 is not necessary for operation of the dispenser apparatus 100, as the dispenser apparatus 100 can be formed with or without the finger groove section 116.

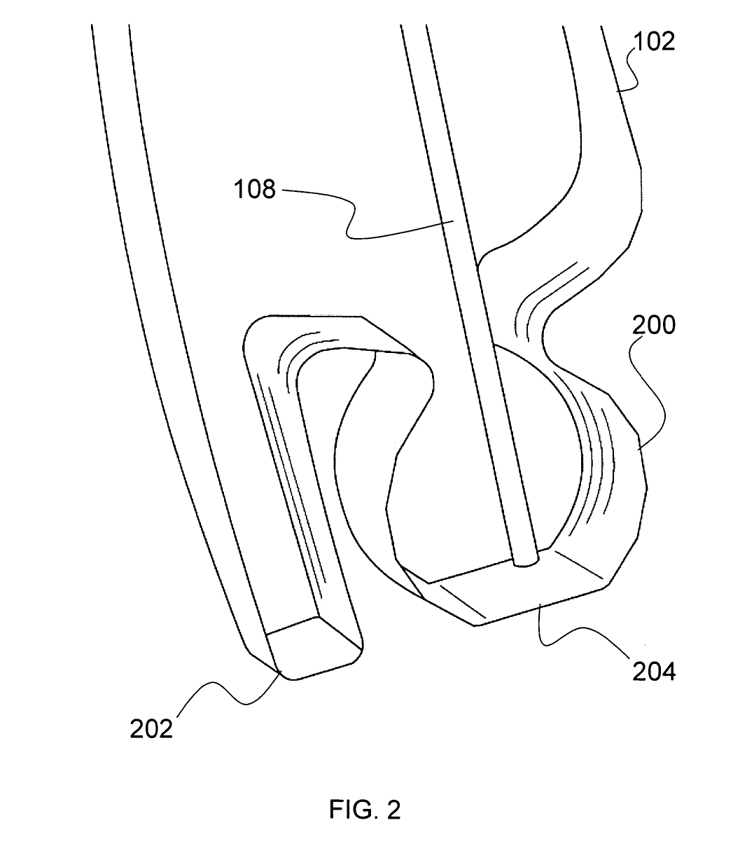

As shown in FIG. 2, the container 102 is formed to have a trapping well 200 and a separate stabilizing well 202. The trapping well 200 includes a bottom portion 204 such that when the dispenser 100 is upright, fluid in the trapping well 200 is directed toward the bottom portion 204. Additionally, the trapping well 200 is formed directly below the neck portion such that the dip tube 108 extends vertically from the dispenser apparatus to the bottom portion 204 of the trapping well 200.

The stabilizing well 202 is formed in a manner that allows the fluid dispenser to stand in an upright position when not being used. As a non-limiting example, the stabilizing well 202 is a well-shaped projection that is formed proximate the trapping well 200 and is in fluid communication with both the trapping well 200 and the container 102. Further, the stabilizing well 202 provides an added benefit of increasing the volume of the container 102. As can be appreciated by one skilled in the art, the stabilizing well 202 is formed at any suitable location to allow the fluid dispenser to stand in an upright position. As illustrated, the stabilizing well 202 can be formed in front of the trapping well 200. Alternatively, it can be formed behind the trapping well 200, alongside the trapping well 200, or at any other suitable location, provided that the dip tube 108 extends vertically from the trapping well 200 to the dispenser apparatus.

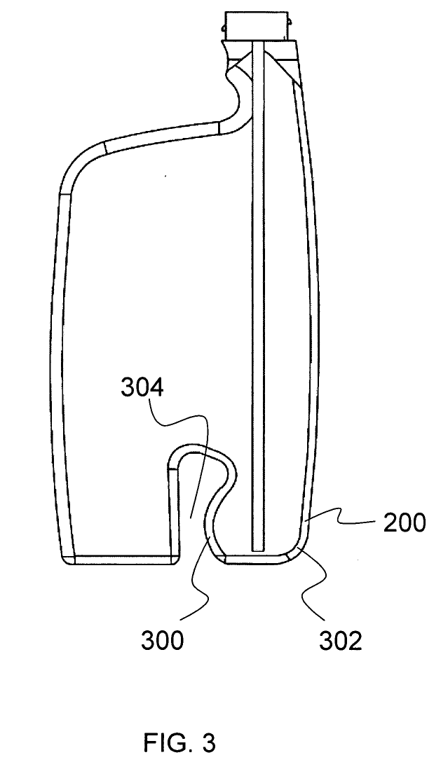

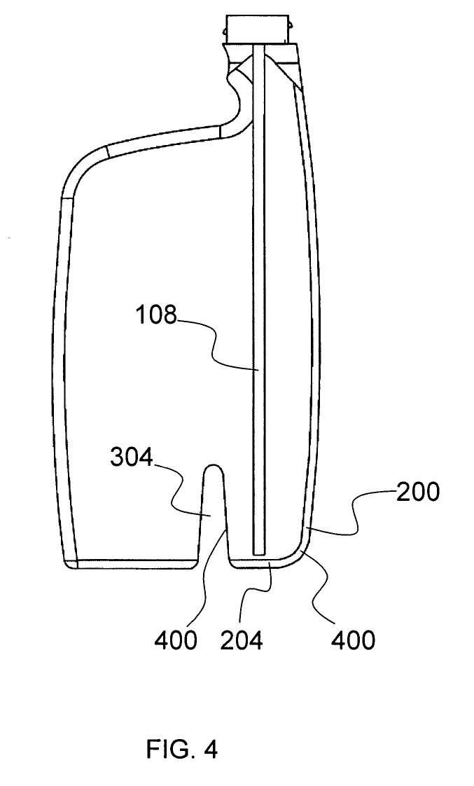

The trapping well 200 is formed in any suitable manner to direct fluid toward the dip tube 108. As a non-limiting example and as shown in FIG. 2, the trapping well 200 is formed in a circular shape such that fluid is directed toward the bottom portion 204 and the dip tube 108. FIGS. 3 and 4 illustrate additional shapes of the trapping well 200. As shown in FIG. 3, the trapping well 200 can be formed to have a circular portion 300 and a tapered portion 302. Alternatively, as shown in FIG. 4, the trapping well 200 can be formed to have tapered portions 400 around (e.g., surrounding) the bottom portion 204. In any form, it is an important aspect of the present invention that when fluid is within the trapping well 200, the fluid is directed towards the bottom portion 204 to be drawn into the dip tube 108. Other non-limiting exemplary shapes of the trapping well include a semi-spherical shape, a tapered-shape, and a conical-shape. Additionally, as illustrated, a space 304 exists between the trapping well 200 and the stabilizing well 202. The space 304 provides a separation of the stabilizing well 202 from the trapping well 200 to further support the fluid dispenser when placed upon a surface.

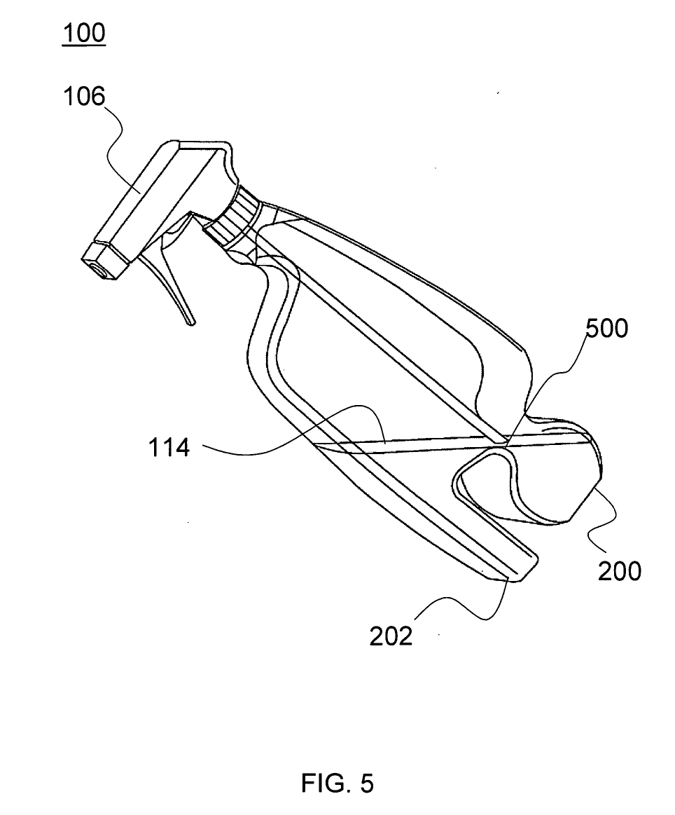

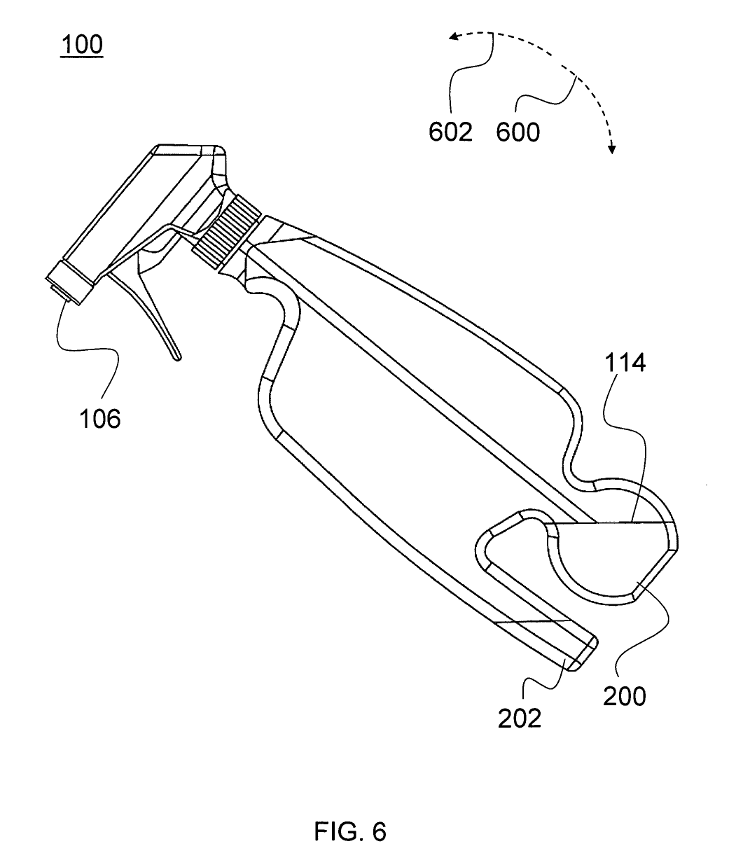

In operation and as shown in FIGS. 5 and 6, when the fluid dispenser 100 is used at low content levels, the fluid 114 will migrate to both the trapping well 200 (e.g., circular-shaped trapping well) and the stabilizing well 202. The shape of the trapping well 200 will allow a user to continue using the fluid dispenser 100 at low content levels. As shown in FIG. 5, the fluid 114 will continue to migrate to both the trapping well 200 and stabilizing well 202 until the fluid 114 level reaches a conjoined top portion 500 of each of the wells. After that point, the user can continue dispensing fluid 114 from the trapping well 200 until it is almost depleted from the trapping well 200, leaving remaining fluid in the stabilizing well 202.

As shown in FIG. 6, to move the contents from the stabilizing well 202 to the trapping well 200, a user can tip the fluid dispenser 100 back 600 so that the dispenser apparatus 106 points upward, then slowly bring the bottle forward 602 and upright to an angle approximately perpendicular to the ground. Such a motion transfers fluid 114 from the stabilizing well 202 into the trapping well 200 to allow the user to further dispense the fluid 114. As shown in FIG. 6, fluid 114 can be continuously transferred to the trapping well 200 (using the process described above) as the level decreases until almost all of the fluid is concentrated in the trapping well 200. The process of tipping the fluid dispenser 100 back 600 and then forward 602 and upright allows a user to dispenser the entire contents of the fluid dispenser 100.

Another advantage of the fluid dispenser (as described and illustrated) is that the container along with the trapping well and stabilizing well can be manufactured using current blow-molding and injection-molding techniques. As described in further detail below, the present invention also includes a method for forming the fluid dispenser described herein.

The method includes an act of forming a container to have both the stabilizing well and trapping well. Additionally, the wells are formed such that a space exists between them. Formation of the space allows the container to be manufactured using existing bottle making techniques (e.g., blow-molding such as extrusion blow-molding, injection blow-molding, and stretch blow-molding.).

In closing, the present invention comprises features of a circular (or semi-spherical) trapping well and stabilizing well that can be incorporated into the overall design of any bottle to deliver liquid contents through a pump spray or pump action mechanism. It is important to note that the present invention can be adapted to any bottle shape and for any volume. In some applications and bottle designs the trapping well and the stabilizing well will be set farther apart than illustrated in the attached figures. The size of the trapping well in relation to the stabilizing well might also differ in various bottle designs. An important aspect of the present invention is that the center of gravity in all bottle designs must fall towards the stabilizing well to insure bottle stability when left alone in an upright position.

What is claimed is:

1. A fluid dispenser, comprising:
a container for holding a fluid, the container having a neck portion for connecting with a dispenser apparatus, and where the container is formed to have a trapping well and a separate stabilizing well, wherein the trapping well includes a bottom portion and is formed such that when upright, fluid in the trapping well is directed to the bottom portion and where the trapping well is also formed such that a dip tube can be extended vertically from a dispenser apparatus to the bottom portion of the trapping well.

2. A fluid dispenser as set forth in claim 1, further comprising:
a dispenser apparatus for dispensing the fluid; and
a dip tube having a first end and a second end, the first end being attached with the dispenser apparatus and the second end being open for drawing the fluid into the dispenser apparatus.

3. A fluid dispenser as set forth in claim 2, wherein the container is formed such that the trapping well is proximate the stabilizing well and a space exists between the trapping well and the stabilizing well.

4. A fluid dispenser as set forth in claim 3, wherein the trapping well is formed in circular shape.

5. A fluid dispenser as set forth in claim 3, wherein the trapping well is formed to have a circular portion and a tapered portion.

6. A fluid dispenser as set forth in claim 3, wherein the trapping well is formed to have tapered portions around the bottom portion.

7. A fluid dispenser as set forth in claim 1, wherein the container includes a finger groove section formed proximate the neck portion, thereby allowing a user to hold the fluid dispenser at least partially through using the finger groove section.

8. A fluid dispenser as set forth in claim 1, wherein the trapping well is formed in circular shape.

9. A fluid dispenser as set forth in claim 1, wherein the trapping well is formed to have a circular portion and a tapered portion.

10. A fluid dispenser as set forth in claim 1, wherein the trapping well is formed to have tapered portions around the bottom portion.

11. A method for forming a fluid dispenser, the method comprising acts of:
forming a container for holding a fluid, the container having a neck portion for connecting with a dispenser apparatus, and where the container is formed to have a trapping well and a separate stabilizing well, wherein the trapping well includes a bottom portion and is formed such that when upright, fluid in the trapping well is directed to the bottom portion and where the trapping well is also formed such that a dip tube can extend vertically from a dispenser apparatus to the bottom portion of the trapping well.

12. A method as set forth in claim 11, further comprising acts of:
forming a dispenser apparatus for dispensing the fluid;
forming a dip tube having a first end and a second end; and
attaching the first end with the dispenser apparatus such that the second end is open for drawing the fluid into the dispenser apparatus.

13. A method as set forth in claim 12, wherein in the act of forming the container, the container is formed such that the trapping well is proximate the stabilizing well and a space exists between the trapping well and the stabilizing well.

14. A method as set forth in claim 13, wherein in the act of forming the container, the container is formed using a blow-molding technique.

15. A method as set forth in claim 14, wherein in the act of forming the container, the container is formed such that the trapping well is circular in shape.

16. A method as set forth in claim 14, wherein in the act of forming the container, the container is formed such that the trapping well has a circular portion and a tapered portion.

17. A method as set forth in claim 14, wherein in the act of forming the container, the container is formed such that the trapping well includes tapered portions around the bottom portion.

18. A method as set forth in claim 11, wherein in the act of forming the container, the container is formed such that the trapping well includes a shape selected from a group consisting of a circular shape, having a circular portion and a tapered portion; and having tapered portions around the bottom portion.

19. A fluid dispenser produced by the method of claim 11.

20. A fluid dispenser produced by the method of claim 12.

21. A fluid dispenser produced by the method of claim 13.

22. A fluid dispenser produced by the method of claim 14.

23. A method for using a fluid dispenser, comprising acts of:
holding a finger groove section formed proximate a neck portion on a container of the fluid dispenser;
drawing a fluid into a dispenser apparatus through a dip tube having a first end and a second end, the first end being attached with the dispenser apparatus and the second end being open for drawing the fluid from a container holding the fluid, and where the container is formed to have a circular trapping well and a separate stabilizing well such that the trapping well is proximate the stabilizing well and a space exists between the trapping well and the stabilizing well, wherein the trapping well includes a bottom portion and is formed such that when upright, fluid in the trapping well is directed to the bottom portion and where the trapping well is also formed such that the dip tube extends vertically from the dispenser apparatus to the bottom portion of the trapping well, such that the fluid is drawn from the bottom portion of the trapping well; and
tipping the fluid dispenser to transfer fluid from the stabilizing well into the trapping well to be drawn into the dip tube.

24. A fluid dispenser, comprising:
a dispenser apparatus for dispensing a fluid;
a dip tube having a first end and a second end, the first end being attached with the dispenser apparatus and the second end being open for drawing the fluid into the dispenser apparatus; and
a container for holding the fluid, the container having a neck portion for connecting with the dispenser apparatus, and where the container is formed to have a circular trapping well and a separate stabilizing well such that the trapping well is proximate the stabilizing well and a space exists between the trapping well and the stabilizing well, wherein the trapping well includes a bottom portion and is formed such that when upright, fluid in the trapping well is directed to the bottom portion and where the trapping well is also formed such that the dip tube extends vertically from the dispenser apparatus to the bottom portion of the trapping well.
